(19) United States
(12) Patent Application Publication
(10) Pub. No.: US 2026/0205709 A1
(43) Pub. Date: Jul. 16, 2026

(54) METHOD FOR WAFER INSECTION AND SYSTEM THEREOF

(71) Applicant: CHENG MEI INSTRUMENT TECHNOLOGY CO., LTD., HSINCHU COUNTY (TW)

(72) Inventors: CHIH-YUAN LIN, HSINCHU COUNTY (TW); CHENG-TAO TSAI, HSINCHU COUNTY (TW); CHENG TING CHIANG, HSINCHU COUNTY (TW)

(21) Appl. No.: 19/020,512

(22) Filed: Jan. 14, 2025

(51) Int. Cl. H04N 23/959; G01N 21/88; G01N 21/95; H04N 23/11

(52) U.S. Cl. CPC H04N 23/959; G01N 21/8806; G01N 21/8851; G01N 21/9501; H04N 23/11

(57) ABSTRACT

A system for wafer inspection includes: a multi-wavelength light source emitting a first light having a first wavelength and a second light having a second wavelength different from the first wavelength to irradiate a wafer to be tested; a camera lens set configured to receive and guide a first reflected light of the first light reflected by the wafer to be tested and receive and guide a second reflected light of the second light reflected by the wafer to be tested, the camera lens set having a first focal length corresponding to the first wavelength, and a second focal length corresponding to the second wavelength and different from the first focal length; an image sensor receiving the first reflected light from the camera lens set to generate a first inspection image, and receiving the second reflected light from the camera lens set to generate a second inspection image.

### FIELD OF THE PRESENT DISCLOSURE

The present disclosure relates to a system for wafer inspection, and more particularly to a system for wafer inspection capable of utilizing different depths of field.

### DESCRIPTION OF THE PRIOR ART

Optical wafer inspection is a technology that uses optical techniques to inspect defects and non-uniformity on a surface of semiconductor wafer, and usually employs high-resolution microscopes and advanced image processing techniques to capture and analyze minute structures and defects on a surface of wafer.

In optical inspection, the depth of field (DOF) is a critical parameter. In an optical system, the depth of field refers to a range in which clear imaging can be maintained while an object moves along a direction of an optical axis. In general, an optical inspection system has a limited depth of field. Thus, when this optical inspection system is used to capture an image, usually only an object within the depth of field can be clearly presented with sharpness in the image, whereas an object outside the depth of field appears more blurry. Thus, when a significant height difference exists on a surface of wafer to be inspected, some area may go beyond the range of depth of field of a lens, leading to a blurred image of such area and thereby affecting the inspection effect. Therefore, there is a need for a solution for an inspection system promoting inspection of an object with a greater range of depth of field.

### SUMMARY OF THE PRESENT DISCLOSURE

A system for wafer inspection is provided according to an embodiment of the present disclosure. The system for wafer inspection includes a multi-wavelength light source, a camera lens set and an image sensor. The multi-wavelength light source emits a first light having a first wavelength and a second light having a second wavelength to irradiate a wafer to be tested, wherein the first wavelength is different from the second wavelength. The camera lens set receives and guides a first reflected light of the first light reflected by the wafer to be tested, and receives and guides a second reflected light of the second light reflected by the wafer to be tested. The camera lens set has a first range of depth of field corresponding to the first wavelength and a second range of depth of field corresponding to the second wavelength, wherein the first range of depth of field is different from the second range of depth of field. The image sensor receives the first reflected light from the camera lens set to generate a first inspection image, and receives the second reflected light from the camera lens set to generate a second inspection image.

A method for wafer inspection is provided according to another embodiment of the present disclosure. The method for wafer inspection includes: irradiating, by a first light having a first wavelength, a wafer to be tested; receiving and guiding, by a camera lens set, a first reflected light of the first light reflected by the wafer to be tested; receiving, by an image sensor, the first reflected light from the camera lens set to generate a first inspection image; irradiating, by a second light having a second wavelength, the wafer to be tested; receiving and guiding, by the camera lens set, a second reflected light of the second light reflected by the wafer to be tested; and receiving, by the image sensor, the second reflected light from the camera lens set to generate a second inspection image. The first wavelength is different from the second wavelength. Moreover, the camera lens set has a first range of depth of field corresponding to the first wavelength and a second range of depth of field corresponding to the second wavelength, wherein the first range of depth of field is different from the second range of depth of field.

### BRIEF DESCRIPTION OF THE DRAWINGS

FIG. 1 is a schematic diagram of a system for wafer inspection according to an embodiment of the present application.

FIG. 2 is a schematic diagram of a focal length and a depth of field of the camera lens set in FIG. 1.

FIG. 3 is a timing diagram of operations the system for wafer inspection in FIG. 1.

FIG. 4 is a schematic diagram of configurations of the image sensor and the camera lens set in FIG. 1.

FIG. 5 is a flowchart of a method for wafer inspection according to an embodiment of the present disclosure.

### DETAILED DESCRIPTION OF THE EMBODIMENTS

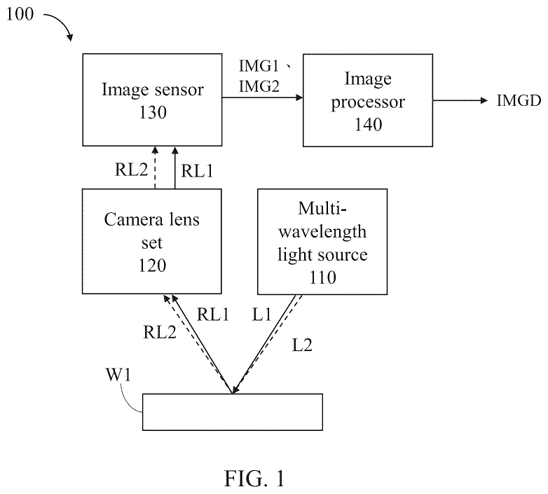

FIG. 1 shows a schematic diagram of a system 100 for wafer inspection according to an embodiment of the present application. The system 100 for wafer inspection includes a multi-wavelength light source 110, a camera lens set 120, an image sensor 130 and an image processor 140.

In the present embodiment, the system 100 for wafer inspection may be used to inspect a surface of wafer W1. The multi-wavelength light source 110 may emit lights of multiple wavelengths to irradiate the wafer W1 to be tested, for example, emitting a first light L1 having a first wavelength to irradiate the wafer W1 and emitting a second light L2 having a second wavelength to irradiate the wafer W1, wherein the first wavelength may be different from the first wavelength. The wafer W1 reflects the first light L1 to generate a first reflected light RL1, and reflects the second light L2 to generate a second reflected light RL2. The camera lens set 120 may guide the first reflected light RL1 and the second reflected light RL2 to the image sensor 130, and the image sensor 130 may sense the first reflected light RL1 and the second reflected light RL2 and accordingly generate images of the surface of the wafer W1.

In the present embodiment, the camera lens set 120 may have a chromatic aberration effect. In other words, the camera lens set 120 may have different focal lengths corresponding to lights of different wavelengths. Thus, by irradiating the wafer W1 by the lights L1 and L2 of different wavelengths, the image sensor 130 can obtain images of different depths of field according to the reflected lights RL1 and RL2, and the image sensor 140 can generate an image having a large depth of field according to the images of different depths of fields, thereby clearly presenting surface features located at different depths in the wafer W1 to facilitate proceeding of wafer inspection.

Although not depicted in FIG. 1, the system 100 for wafer inspection of the present disclosure may further include an optical path adjustment device for adjusting an optical path of the multi-wavelength light source 110, so that the first light L1 and the second light L2 are able to enter the wafer W1 to be tested at appropriate angles. Moreover, the optical path adjustment device may also guide the first reflected light RL1 and the second reflected light RL2 generated by reflecting the first light L1 and the second light L2 by the wafer W1, so that the first reflected light RL1 and the second reflected light RL2 are able to enter the camera lens set 120. The camera lens set 120 may receive and guide the first reflected light RL1 of the first light L1 reflected by the wafer W1, and may receive and guide the second reflected light RL2 of the second light L2 reflected by the wafer W1. In such case, the image sensor 130 may receive the first reflected light RL1 from the camera lens set 120 to generate a first inspection image IMG1 of the wafer W1, and receive the second reflected light RL2 from the camera lens set 120 to generate a second inspection image IMG2.

In the present embodiment, since the camera lens set 120 may have different focal lengths to correspond to different wavelengths, the first inspection image IMG1 and the second inspection image IMG2 may correspond to different depths of field. In other words, some surface features (for example, features located within a first range of depth of field) of the wafer W1 may be clearly presented in the first detection image IMG1 but cannot be clearly presented in the second inspection image IMG2. In contrast, some other surface features (for example, features located within a second range of depth of field) of the wafer W1 may be clearly presented in the second detection image IMG2 but cannot be clearly presented in the first inspection image IMG1. In such case, the image processor 140 may calculate and overlay the first inspection image IMG1 and the second inspection image IMG2 by an appropriate image processing algorithm to thereby generate an inspection image IMGD having a large depth of field. In the inspection image IMGD having a large depth of field, both the surface features within the first range of depth of field and the surfaces features within the second range of depth of field can be presented, hence better improving the accuracy of wafer inspection.

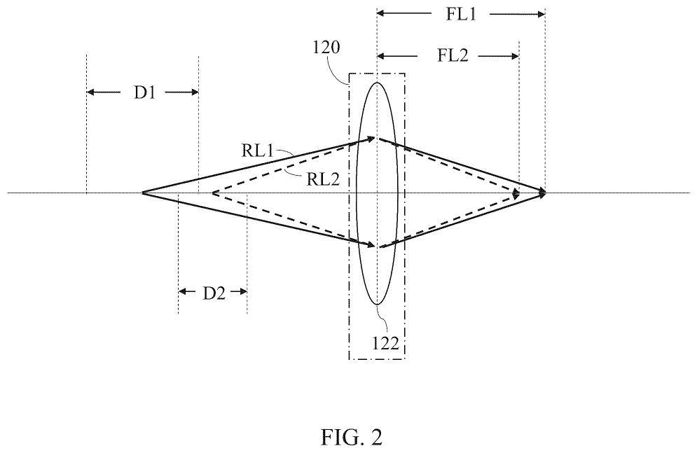

FIG. 2 shows a schematic diagram of a focal length and a depth of field of the camera lens set 120 according to an embodiment of the present disclosure. In the present embodiment, the camera lens set 120 may include a chromatic lens 122, which may be, for example, a spherical lens; however, the present disclosure is not limited to the example above. As shown in FIG. 2, the camera lens set 120 may have a first focal length FL1 to correspond to the first reflected light RL1 having the first wavelength, and may have a second focal length FL2 to correspond to the second reflected light RL2 having the second wavelength.

In such case, when the wafer W1 is irradiated by the first light L1 having the first wavelength, the features within a first range of depth of field D1 on the surface of the wafer W1 can be clearly presented in the first inspection image IMG1, and the features within a second range of depth of field D2 on the surface of the wafer W1 can be clearly presented in the second inspection image IMG2. In the present embodiment, the image processor 140 may generate the inspection image IMGD having a large depth of field according to the first inspection image IMG1 and the second inspection image IMG2 and by using an appropriate image processing algorithm, for example but not limited to, an unsharp masking algorithm. In some embodiments, the range of depth of field corresponding to the inspection image IMGD includes the first range of depth of field D1 corresponding to the first inspection image IMG1 and the second range of depth of field D2 corresponding to the second inspection image IMG2. As such, both of the features within the first range of depth of field D1 and the features within the second range of depth of field D2 on the surface of the wafer W1 can be clearly presented in the inspection image IMGD, and the system 100 for wafer inspection can then perform inspection on the surface features of the wafer W1 according to the inspection image IMGD having a large range of depth of field, thereby improving the inspection accuracy.

In some embodiments, in order to correspond the inspection image IMGD to a continuous range of depth of field, the first range of depth of field D1 and the second range of depth of field D2 can be partially overlapping; however, the present disclosure is not limited to the example above. Moreover, in order to provide the inspection image IMGD with a greater range of depth of field, in some embodiments, the difference between the first wavelength of the first light L1 and the second wavelength of the second light L2 may be greater than 150 nm. For example, the first wavelength and the second wavelength may respectively correspond to any two of ultraviolet light, visible light and infrared light. For example, the first light L1 may be infrared light, and the second light L2 may be ultraviolet light. However, the present disclosure is not limited to the examples above. In some embodiments, the first wavelength and the second wavelength may respectively correspond to lights in different colors in visible light.

In addition, in some embodiments, the image sensor 130 may simultaneously sense lights of different wavelengths; however, the present disclosure is not limited to the example above. In some embodiments, in order to prevent interference during sensing, the multi-wavelength light source 110 may emit lights of different wavelengths in different periods of time, and the image sensor 130 may also correspondingly sense lights of different wavelengths in different periods of time.

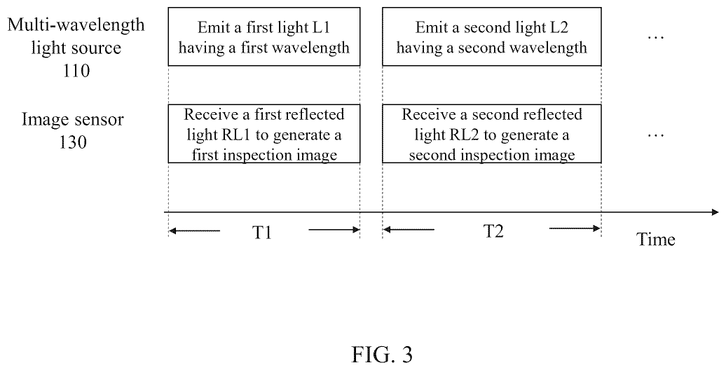

FIG. 3 shows a timing diagram of operations of a system 100 for wafer inspection according to an embodiment of the present disclosure. As shown in FIG. 3, in a first period T1, the multi-wavelength light source 110 may emit the first light L1 of the first wavelength to irradiate the wafer W1. At this point, the image sensor 130 may receive the first reflected light RL1 and generate the first inspection image IMG1. Next, in a second period T2, the multi-wavelength light source 110 may emit the second light L2 of the first wavelength to irradiate the wafer W1. At this point, the image sensor 130 may receive the second reflected light RL2 and generate the second inspection image IMG2. In the present embodiment, the first period T1 and the second period T2 do not overlap, hence preventing the image sensor 130 from interference imposed by the second reflected light RL2 while the image sensor 130 receives the first reflected light RL1 and generates the first inspection image IMG1, as well as preventing the image sensor 130 from interference imposed by the first reflected light RL1 while the image sensor 130 receives the second reflected light RL2 and generates the second inspection image IMG2.

Moreover, in the present embodiment, the image sensor 130 may have an adjustable sensing waveband. That is to say, a center wavelength sensed by the image sensor 130 is adjustable. In such case, the sensing waveband of the image sensor 130 may be set to have the first wavelength as the center during the first period T1 to thereby generate the first inspection image IMG1, and set to have the second wavelength as the center during the second period T2 to thereby generate the second inspection image IMG2. As such, the influences of lights of other wavebands upon the image sensor 130 can be reduced while the image sensor 130 generates the first inspection image IMG1 or the second inspection image IMG2.

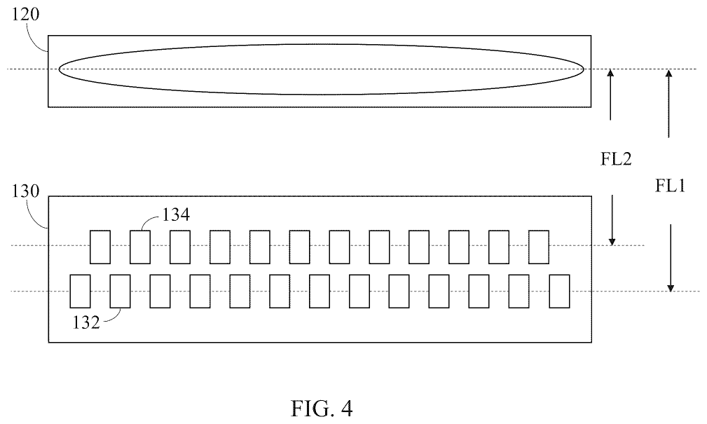

FIG. 4 shows a schematic diagram of configurations of the image sensor 130 and the camera lens set 120 according to an embodiment of the present disclosure. In the embodiment in FIG. 4, the image sensor 130 may include optical sensing units 132 and 134 for sensing lights of different wavelengths. In such case, the optical sensing unit 132 for sensing the first wavelength may be enabled and the optical sensing unit 134 for sensing the second wavelength may be disabled, thereby setting the first wavelength as the center of the sensing waveband of the image sensor 130. In contrast, the optical sensing unit 134 may be enabled and the optical sensing unit 132 may be disabled, thereby setting the second wavelength as the center of the sensing waveband of the image sensor 130. As such, power consumption can be reduced, and a sensing result of an optical sensing unit of a non-predetermined wavelength can be prevented from mixing into an inspection image corresponding to a predetermined wavelength. However, the present disclosure is not limited to the examples above. In some embodiments, when the first wavelength is set as the center of a sensing waveband, it is not necessary to disable the optical sensing unit 134, and data sensed by the optical sensing unit 134 may be merely omitted or left unread instead.

Since the camera lens set 120 may have different focal lengths to correspond to lights of different wavebands, the position of an imaging plane of the first inspection image IMG1 may differ from the position of an imaging plane of the second inspection image IMG2. In some embodiments, in addition to having an adjustable waveband, the image sensor 130 may further have a sensing plane with an adjustable position. As such, while the sensing waveband is adjusted, the position of a sensing plane can also be correspondingly adjusted, thereby allowing the image sensor 130 to obtain a clearer image.

For example, when the first wavelength is set as the center of the sensing waveband of the image sensor 130, the sensing plane of the image sensor 130 may also be adjusted to a position of the focal length FL1. In contrast, wen the second wavelength is set as the center of the sensing waveband of the image sensor 130, the sensing plane of the image sensor 130 may be adjusted to a position of the focal length FL2. As such, the image sensor 130 can more accurately generate the first inspection image IMG1 according to the first reflected light RL1, and more accurately generate the second inspection image IMG2 according to the second reflected light RL2.

As shown in FIG. 4, in the image sensor 130, the optical sensing units 132 and 134 for sensing lights of different wavelengths can be arranged on different planes according to the focal length of the camera lens set 120. Thus, when the sensing waveband is adjusted, the position of the sensing plane is also adjusted. For example, when the first wavelength is set as the center of the sensing waveband of the image sensor 130 (that is, when the optical sensing unit 132 for sensing the first wavelength is enabled and the optical sensing unit 134 not for sensing the first wavelength is disabled), the sensing plane is at the same time set on the focal length FL1 of the camera lens set 120. In contrast, when the second wavelength is set as the center of the sensing waveband of the image sensor 130 (that is, when the optical sensing unit 134 for sensing the second wavelength is enabled and the optical sensing unit 132 not for sensing the second wavelength is disabled), the sensing plane is at the same time set on the focal length FL2 of the camera lens set 120. As such, the sensing waveband and the position of the sensing plane of the image sensor 130 can be simultaneously adjusted.

However, the present disclosure does not define that the image sensor 130 needs to have an adjustable sensing waveband or an adjustable sensing plane. In some embodiments, if the difference between the focal length FL1 and the focal length FL2 is within an acceptable range, the sensing plane of the image sensor 130 may also be fixed at a predetermined position instead of being adjustable by a user. In such case, the optical sensing unit 132 and the optical sensing unit 134 may also be arranged on the same plane.

In the embodiment in FIG. 1, the system 100 for wafer inspection may generate the first light L1 having the first wavelength and the second light L2 having the second wavelength by the multi-wavelength light source 110 to irradiate the surface of the wafer W1, and receive the first reflected light RL1 having the first wavelength and the second reflected light RL2 having the second wavelength by the camera lens set 120 to generate the inspection images IMG2 and IMG2 having different ranges of depth of fields, thereby accordingly generating the inspection image having a large range of depth of field. However, the present disclosure is not limited thereto. In some embodiments, the system 100 for wafer inspection may generate lights of different wavelengths (for example, lights of three different wavelengths, or lights of four different wavelengths) by the multi-wavelength light source 110, obtain inspection images of the wafer W1 corresponding to different ranges of depth of field (for example, three ranges of depth of field or four ranges of depth of field) based on the chromatic property of the camera lens set 120, and then accordingly generate an inspection image having an even larger range of depth of field.

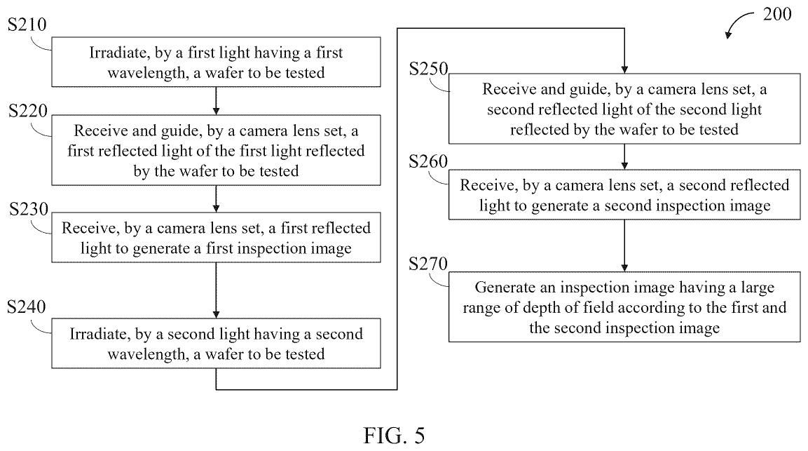

FIG. 5 shows a flowchart of a method 200 for wafer inspection according to an embodiment of the present disclosure. As shown in FIG. 5, the method 200 may include steps S210 to S270. In some embodiments, the method 200 may be performed by the system 100 for wafer inspection.

For example, in step S210, the multi-wavelength light source 110 may generate the first light L1 of the first wavelength to irradiate the wafer W1 to be tested. In such case, the wafer W1 reflects the first light L1 to generate the first reflected light RL1, and the camera lens set 120 may receive and guide the first reflected light RL1 for the first reflected light RL1 to enter the image sensor 130 in step S220. Then, in step S230, the image sensor 130 may generate the first inspection image IMG1 according to the first reflected light RL1.

Similarly, in step S240, the multi-wavelength light source 110 may generate the second light L2 of the second wavelength to irradiate the wafer W1 to be tested. In such case, the wafer W1 reflects the second light L2 to generate the second reflected light RL2, and the camera lens set 120 may receive and guide the second reflected light RL2 for the second reflected light RL2 to enter the image sensor 130 in step S250. Then, in step S260, the image sensor 130 may generate the second inspection image IMG2 according to the second reflected light RL2.

Due to the chromatic property of the camera lens set 120, the camera lens set 120 has different depths of field to correspond to the first reflected light RL1 and the second reflected light RL2 of different wavelengths. In such case, the first inspection image IMG1 and the second inspection image IMG2 generated according to the first reflected light RL1 and the second reflected light RL2 also have different ranges of depth of field. In step S270, the image processor 140 may process the first inspection image IMG1 and the second inspection image IMG2 by an appropriate image processing method to generate the inspection image IMGD having a large depth of field. As such, with the method 200, the surface features of the wafer W1 may be inspected according to the inspection image IMGD having a large range of depth of field, thereby improving the inspection accuracy.

In summary, the system for wafer inspection and the method for wafer inspection provided by the embodiments of the present application can irradiate a wafer by lights of different wavelengths, obtain inspection images corresponding to different ranges of depth of field by a camera lens set with a chromatic property, and then generate an inspection image having a large range of depth of field according to the inspection images of different ranges of depth of field. In such case, the system for wafer inspection and the method for wafer inspection can inspect the surface features of the wafer by using the inspection image having a large range of depth of field, thereby improving the inspection accuracy.

1. A system for wafer inspection, comprising:
a multi-wavelength light source, configured to emit a first light having a first wavelength and a second light having a second wavelength to irradiate a wafer to be tested, wherein the first wavelength is different from the second wavelength;
a camera lens set, configured to receive and guide a first reflected light of the first light reflected by the wafer to be tested, and receive and guide a second reflected light of the second light reflected by the wafer to be tested, the camera lens set having a first range of depth of field corresponding to the first wavelength and a second range of depth of field corresponding to the second wavelength, wherein the first range of depth of field is different from the second range of depth of field, and the first range of depth of field partially overlaps with the second range of depth of field, and the first range of depth of field and the second range of depth of field jointly form a continuous combined depth of field; and
an image sensor, configured to receive the first reflected light from the camera lens set to generate a first inspection image corresponding to the first range of depth of field, and receive the second reflected light from the camera lens set to generate a second inspection image corresponding to the second range of depth of field.

2. The system for wafer inspection according to claim 1, further comprising:
an image processor, configured to generate an inspection image having a large range of depth of field according to the first inspection image and the second inspection image;
wherein a range of depth of field corresponding to the inspection image having the large range of depth of field comprises the first range of depth of field and the second range of depth of field.

3. The system for wafer inspection according to claim 1, wherein:
the multi-wavelength light source emits the first light in a first period, and the image sensor receives the first reflected light in the first period;
the multi-wavelength light source emits the second light in a second period, and the image sensor receives the second reflected light in the second period; and
the first period and the second period do not overlap.

4. The system for wafer inspection according to claim 1, wherein a difference between the first wavelength and the second wavelength is greater than 150 nm.

5. The system for wafer inspection according to claim 1, wherein the first wavelength and the second wavelength respectively correspond to any two of ultraviolet light, visible light and infrared light.

6. The system for wafer inspection according to claim 1, wherein the first wavelength and the second wavelength respectively correspond to lights in different colors in visible light.

7. The system for wafer inspection according to claim 1, wherein the image sensor has an adjustable sensing waveband, the image sensor generates the first inspection image when the first wavelength is set as a center of the sensing waveband, and generates the second inspection image when the second wavelength is set as the center of the sensing waveband.

8. The system for wafer inspection according to claim 1, wherein the image sensor has an adjustable sensing plane, the sensing plane of the image sensor is adjusted to a first focal length of the camera lens set corresponding to the first wavelength to generate the first inspection image, and is adjusted to a second focal length of the camera lens set corresponding to the second wavelength to generate the second inspection image.

9. The system for wafer inspection according to claim 1, wherein the camera lens set comprises a chromatic lens.

10. A method for wafer inspection, comprising:
irradiating, by a first light having a first wavelength, a wafer to be tested;
receiving and guiding, by a camera lens set, a first reflected light of the first light reflected by the wafer to be tested;
receiving, by an image sensor, the first reflected light from the camera lens set to generate a first inspection image corresponding to a first range of depth of field;
irradiating, by a second light having a second wavelength, the wafer to be tested, wherein the first wavelength is different from the second wavelength;
receiving and guiding, by the camera lens set, a second reflected light of the second light reflected by the wafer to be tested, wherein the camera lens set has the first range of depth of field corresponding to the first wavelength and a second range of depth of field corresponding to the second wavelength, wherein the first range of depth of field is different from the second range of depth of field, and the first range of depth of field partially overlaps with the second range of depth of field, and the first range of depth of field and the second range of depth of field jointly form a continuous combined depth of field; and
receiving, by the image sensor, the second reflected light from the camera lens set to generate a second inspection image corresponding to the second range of depth of field.

11. The method according to claim 10, further comprising:
generating an inspection image having a large range of depth of field according to the first inspection image and the second inspection image;
wherein a range of depth of field corresponding to the inspection image having the large range of depth of field comprises the first range of depth of field and the second range of depth of field.

12. The method according to claim 10, wherein:
the steps of irradiating, by the first light having the first wavelength, the wafer to be tested, receiving and guiding, by the camera lens set, the first reflected light of the first light reflected by the wafer to be tested, and receiving, by the image sensor, the first reflected light from the camera lens set to generate the first inspection image are performed in a first period;
the steps of irradiating, by the second light having the second wavelength, the wafer to be tested, receiving and guiding, by the camera lens set, the second reflected light of the second light reflected by the wafer to be tested, and receiving, by the image sensor, the second reflected light from the camera lens set to generate the second inspection image are performed in a second period; and
the first period and the second period do not overlap.

13. The method according to claim 10, wherein a difference between the first wavelength and the second wavelength is greater than 150 nm.

14. The method according to claim 10, wherein the first wavelength and the second wavelength respectively correspond to any two of ultraviolet light, visible light and infrared light.

15. The method according to claim 10, wherein the first wavelength and the second wavelength respectively correspond to lights in different colors in visible light.

16. The method according to claim 10, further comprising:
setting the first wavelength as a center of a sensing waveband of the image sensor to generate the first inspection image; and
setting the second wavelength as the center of the sensing waveband of the image sensor to generate the second inspection image.

17. The method according to claim 10, further comprising:
adjusting a sensing plane of the image sensor to a first focal length of the camera lens set corresponding to the first wavelength to generate the first inspection image; and
adjusting the sensing plane of the image sensor to a second focal length of the camera lens set corresponding to the second wavelength to generate the second inspection image.

18. The method according to claim 10, wherein the camera lens set comprises a chromatic lens.
